(19) United States
(12) Patent Application Publication
(10) Pub. No.: US 2013/0199186 A1
(43) Pub. Date: Aug. 8, 2013

(54) Fan-less Thrust Generating Component for Air-bypass Engine

(71) Applicant: Ahmed Yassin SOUEIDAN, Columbia, IL (US)

(72) Inventor: Ahmed Yassin SOUEIDAN, Columbia, IL (US)

(21) Appl. No.: 13/591,977

(22) Filed: Aug. 22, 2012

Related U.S. Application Data
(60) Provisional application No. 61/526,456, filed on Aug. 23, 2011.

(51) Int. Cl. F02C 5/00

(52) U.S. Cl. CPC F02C 5/00
USPC 60/722

(57) ABSTRACT

A fan-less thrust generating component for air-bypass engine includes an outer casing, a fluid moving device, and a plurality of core components. The fluid moving device and the plurality of core components are positioned within an intake opening of the outer casing. The fluid moving device is positioned in front of the plurality of core components and connected to with the plurality of core components. The fluid moving device includes a hub, a helical fin, and a fluid inlet. The helical fin is connected around the hub and the fluid inlet is positioned on the helical fin. The fluid moving device pulls air fluid into the intake opening through the fluid inlet upon rotation so that thrust can be generated within the air-bypass engine.

The current application claims a priority to the U.S. Provisional Patent application Ser. No. 61/526,456 filed on Aug. 23, 2011.

### FIELD OF THE INVENTION

The present invention relates generally to an apparatus for air bypass engines. More specifically, the present invention is an alternative modification for air-bypass engines, which directly replaces the turbofan with a fan-less thrust generating device.

### BACKGROUND OF THE INVENTION

The call to address the increasing bird strike threat to commercial aircraft is at the most critical moment in aviation history. Bird impacts to aircraft engines jeopardize the public safety, airline profits, and well-being of flight crew and civilians aboard commercial aircraft and on the ground. The fan blades of the turbofan, responsible for ingesting large amounts of air for thrust, are the most vulnerable component during a bird strike. The slightest damage to this component from foreign body impact, sometimes unknowingly, can result in catastrophic consequences for public safety and engine performance. Current deterrence methods to reduce bird strike risks are simply not enough to conflict with the increasing bird population and congestion of passengers in airports.

With the current aircraft industry in financial turmoil, the extended downtime, repair, and in some cases the replacement of a bird struck component, is simply too much to afford. Through known numerical simulations citing the initial onset of damage to fan blades at 110 mph, not many can afford the $24 million expenses for an aircraft engine replacement. Complications arise when addressing the impact resistance of current fan module designs. The weight of the fan blades directly affect engine performance and efficiency and are the number one dilemma for aircraft designers and engineers to further protect aircraft engines from bird collisions.

An alternative conception is to modify the shape of the fan module geometry to provide an adequate measure of strength to resist the impact loading from bird and other foreign body collisions. The rising threats of foreign body impacts to civilian aircraft impose safety, financial, and environmental risks to flight transportation. A foreign body collision with commercial aircraft is a concern to public safety and creates unwanted aircraft downtime and repairs.

The most vital element to any aircraft is propulsion or thrust. The turbofan engine is the powerhouse for the majority of commercial airliners. Because the turbofan engine is the most vulnerable component and has a 32% chance to be struck and damaged, special attention and strict certification requirements are in place to prove their capability to withstand the harshest of impact loadings. With current turbofan configurations, even the most minimal impact damage to the fan blades can lead to engine destabilization which affects operation and efficiency leading to an emergency ground and downtime for repairs. Aircraft downtime as a result from aero engine damage, with 150 hours of downtime per incident, leads to increased airport and runway congestion. Furthermore, damage to aero engines is usually not covered by aircraft engine insurance. With the current aviation industry already in a financial fiasco, they simply cannot afford the price tag of a luxury car in exchange for a turbofan blade replacement.

Most commercial airliners are equipped with turbofan engines to produce thrust. Each turbofan engine from the entrance to exist contains an inlet, a fan module, fan containment structure, low and high-pressure compressors, high and low-pressure turbines, and an exhaust. The low pressure compressor, the low pressure turbine, and the low pressure shaft complete a low pressure (LP) unit. The high pressure compressor, the high pressure turbine, and the high pressure shaft complete a high pressure (HP) unit. The fan module is typically attached to the low pressure shaft and draws in as much air as possible through the inlet into the engine. The turbofan component generates the greatest amount of total engine thrust by passing air internally. Approximately 75% of the air flow from the fan module is bypassed and used for thrust. The remaining air enters through the low and high-pressure compressors and the thermodynamic principles of fuel air combustion drive the rotation of the low pressure and high pressure shafts through the low and high-pressure turbines and out the exhaust. This cycle powers the turbofan engine with the fan module being the most critical aspect of the design. The protection and inspection of the fan blades are vital when practicing flight hazard prevention. The turbofan fan module located on the rotor and stator is the first component to be struck in the event of a foreign body impact. The last line of defense from a strike to an aircraft engine is the fan containment structure. This outer protective layer is designed and tested to permit for the containment of a fractured fan blade resulting from foreign object damage (FOD). The federal aviation administration (FAA) describes this event as fan blade out (FBO), and requires the containment structure to protect the fuselage from any shrapnel or high speed particles during impact.

While protecting against primary damage, secondary damage is also a concern when fan rotor unbalance causing further harm resulting from severe vibration which can also lead to an engine shutdown. Because of the fan blade fragility and intricate geometrical design, this component is the main cause of engine performance drop or operational failure due to impact loading from a foreign object or bird. Aircraft fan blade designers continue to address the problem with bird impact loading on these components by researching more impact resistant configurations. Some coat the fan blades with polyurethane and protect them with a layer of titanium above the composite. Even with bird deterrence and newer fan blade designs, the bird strike threat continues to rise. The main weakness to the fan blade design may be contributed from the lightweight material used, and temperamental airfoil geometry. Generally, composite materials for fan blades contain a poor ability to absorb energy and are prone to fiber splitting. Fan module improvement design is restricted to the density of the blades and geometrical shape. The components that correspond with the module are dependent upon its ability to perform adequately. Because a significant loss of thrust can transpire through the slightest fan blade deformation, this fragile component is demanded to perform under the most rigorous testing while satisfying realistic performance. Unfortunately, lightweight and high strength attributes do not go hand in hand with fan module performance and protection. A fan module too heavy, the plane will not get off the ground, and too light will undermine its stiffness.

Bird proofing fan blades to further increase impact resistance would depreciate the performance of the later components and largely affect the overall engine efficiency. Reconfiguring the geometrical arrangement of the fan module appears to be the fundamental conception while conserving the modular weight. The invention is an alternative modification for air-bypass engines, which directly replaces the turbofan with a fan-less thrust generating device. The fluid moving geometry is a helix and substitutes the turbofan's purpose.

Furthermore to having a more rigid inlet on air-bypass engines to protect against foreign body impacts, the fan-less thrust generating device decreases manufacturing costs and increases design flexibility due to simple construction while requiring less maintenance during service. A more balanced rotation could be achieved to provide for improved engine stability during operation. The performance and efficiency of aircraft engines could be improved due to a higher stiffness/weight ratio on the rotor.

### BRIEF DESCRIPTION OF THE DRAWINGS

FIG. 1 is a perspective view of the present invention.

FIG. 2 is a side view of the present invention showing some of the inside components.

FIG. 3 is a perspective view of the present invention showing some of the inside components.

FIG. 4 is a perspective inside view of a plurality of core components of the present invention.

FIG. 5 is a side view of the present invention showing the plurality of core components.

FIG. 6 is a perspective view of a fluid moving device, a high spool, and a low spool of the present invention.

FIG. 7 is a side view of the fluid moving device, the high spool, and the low spool of the present invention.

FIG. 8 is a side view of the fluid moving device and the low spool of the present invention.

FIG. 9 is a side view of the high spool of the present invention.

FIG. 10 is a front perspective view of the fluid moving device of the present invention.

FIG. 11 is a back perspective view of the fluid moving device of the present invention.

FIG. 12 is a side view of the fluid moving device of the present invention, where the fluid moving device is positioned in the 0 degree rotational angle.

FIG. 13 is a side view of the fluid moving device of the present invention, where the fluid moving device is positioned in the 90 degree rotational angle.

FIG. 14 is a side view of the fluid moving device of the present invention, where the fluid moving device is positioned in the 180 degree rotational angle.

FIG. 15 is a side view of the fluid moving device of the present invention, where the fluid moving device is positioned in the 270 degree rotational angle.

FIG. 16 is a perspective view of the fluid moving device shown in a different embodiment.

FIG. 17 is a perspective view of the fluid moving device showing material construction in a helical fin.

FIG. 18 is a diagram of the material composition in the helical fin of the present invention.

### DETAIL DESCRIPTIONS OF THE INVENTION

All illustrations of the drawings are for the purpose of describing selected versions of the present invention and are not intended to limit the scope of the present invention.

The present invention is an alternative modification for air-bypass engines, which directly replaces the turbofan with a fan-less thrust generating device. A system of the fan-less thrust generating apparatus comprises an outer casing 1, a fluid moving device 2, and a plurality of core components 3.

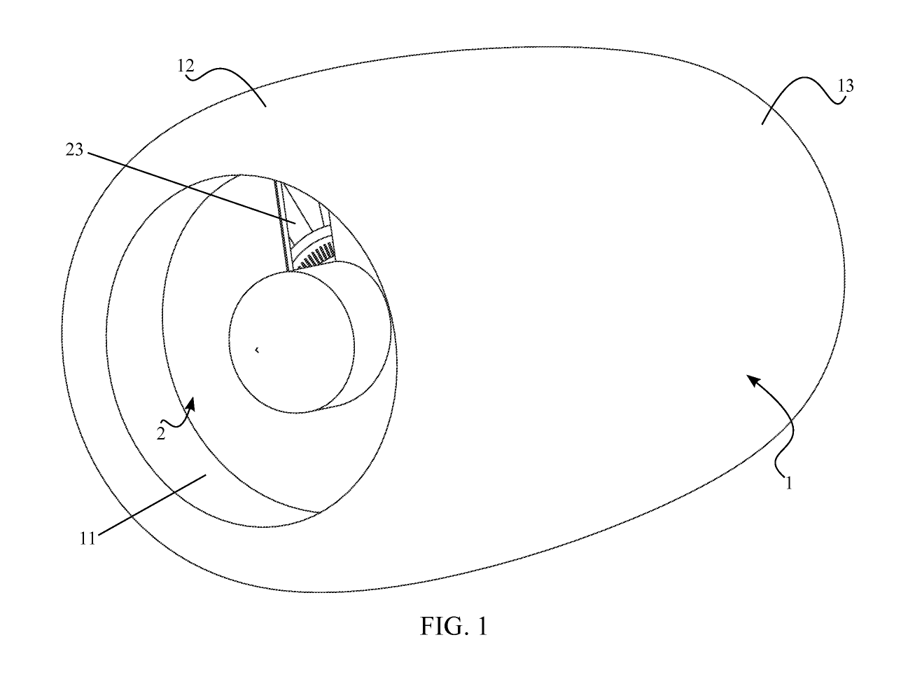

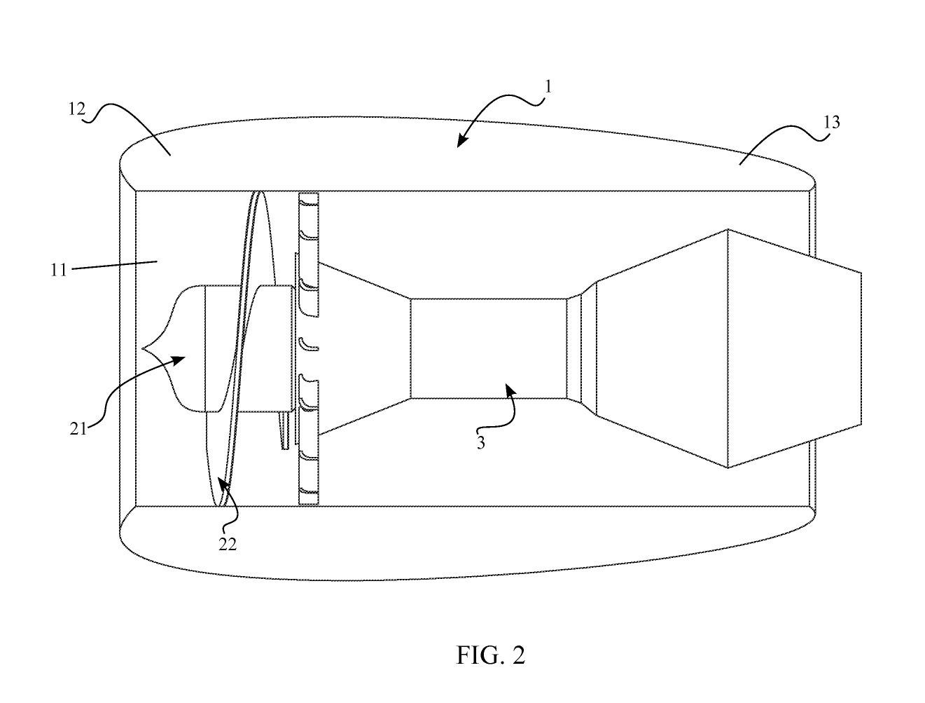

The outer casing 1 comprises a front end 12, a back end 13, and an intake opening 11. The outer casing 1 is positioned as the exterior body in the present invention. In reference to FIG. 1, the outer casing 1 includes an aerodynamic-shape so that the outer casing 1 minimizes the drag. The front end 12 and the back end 13 are oppositely positioned in the outer casing 1. The front end 12 is positioned in the front half of the outer casing 1, and the back end 13 is positioned in the back half of the outer casing 1. The intake opening 11 is concentrically traversed through the front end 12 and the back end 13.

The fluid moving device 2 comprises a hub 21, a helical fin 22, and a fluid inlet 23. The fluid moving device 2 is a direct replacement for turbofan modules on existing turbofan engines. The objective of the present invention is to solve the bird strike threat to aircraft engines by increasing the rigidity of the inlet and to further protect aircraft engine's function in the event of foreign body collisions, in addition to enhancements on the helical fin 21 and its configuration. The fluid moving device 2 operates similarly to the turbofan configuration by thrusting air fluid through the engine. In reference to FIG.

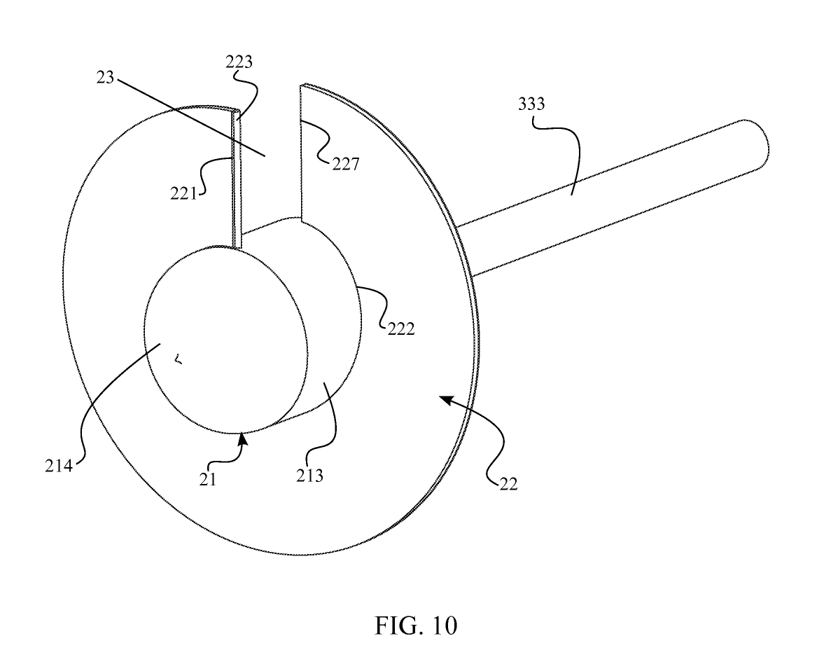

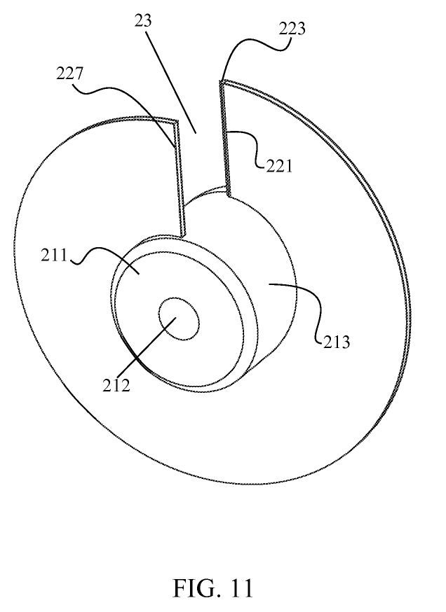

2, the fluid moving device 2 is positioned within the intake opening 11 and adjacently positioned with the front end 12. The helical fin 22 is radially extended around the hub 21, and the fluid inlet 23 is adjacently positioned with the helical fin 22. In reference to FIG. 10, the hub 21 comprises a flat surface 211, a cylindrical section 213, and a conical section 214. The cylindrical section 213 is positioned in between the flat surface 211 and the conical section 214. The flat surface 211 and the conical section 214 are both connected to the cylindrical section 213. In reference to FIG. 11, a connector cavity 212 is concentrically traversed through the flat surface 211 and the cylindrical section 213. The connector cavity 212 connects the hub 21 with the plurality of core components 3. The conical section 214 is considered as the impact side of the hub 21 since the conical section 214 faces towards the atmospheric air.

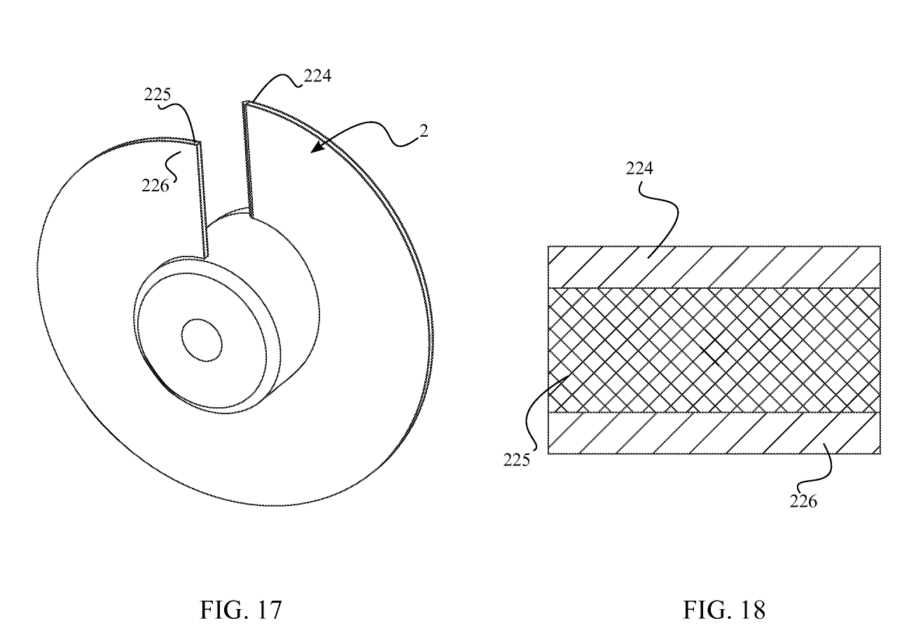

The helical fin 22 comprises a starting end 221, a final end 227, a first layer 224, a middle layer 225, a second layer 226, an inside rim 222, and an inlet edge 223. The helical fin 22 comprises geometric shape of a helix and substitutes instead of the turbofan purpose. The inside rim 222 is concentrically positioned within the helical fin 22. The middle layer 225 is positioned in between the first layer 224 and the second layer 226, and the first layer 224 and the second layer 226 are connected to the middle layer 225 creating a single layer. Because of the intense impulsive loads from bird collisions, the helical fin 22 requires careful attention to material construction and geometry. In reference to FIG. 17 and FIG. 18, the material selection for the helical fin 22 should lie within the domain of shock absorption properties. Common configurations for shock absorption include the use of sandwich materials. These include two faces and a core replicating the layers of a sandwich. In the present invention, the first layer 224, the middle layer 225, and the second layer 226 are used in the helical fin 22 to absorb the shock waves from an impulsive load. In the preferred embodiment, the middle layer 225 is thicker than the first layer 224 and the second layer 226. Ideal shock absorbing materials, such as structured lattice or honeycomb, or shock absorbing polymers, rubber, neoprene, silicone, or polyurethane, can be used as the middle layer 225. The first layer 224 and the second layer 226 can be made from light weighted and high strength metals such as aluminum 6061. The first layer 224 of the helical fin 22 may be reinforced with titanium to further increase its impact resistance.

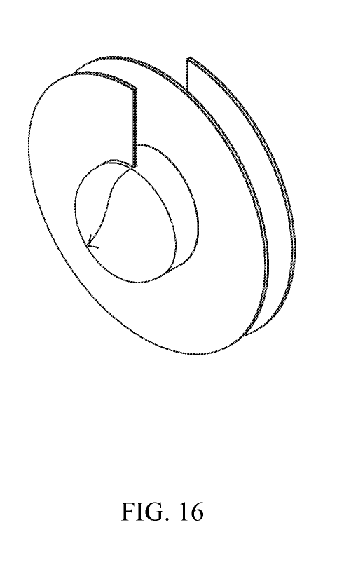

The first layer 224, the middle layer 225, and the second layer 226 are radially positioned from the inside rim 222. In reference to FIG. 10, the inside rim 222 is connected around the cylindrical section 213 where the helical fin 22 connects with the hub 21. The starting end 221 and the final end 227 are also adjacently positioned with the hub 21. The starting end 221 corresponds with one end of the helical fin 22 while the final end 227 corresponds with other end of the helical fin 22. The starting end 221 is adjacently connected below the conical section 214, and the final end 227 is adjacently connected with the flat surface 211. The helical fin 22 replicates the geometry of screw threads with an optimal pitch and revolution for air fluid moving performance and structural integrity. The pitch and revolution are carefully considered to accommodate difference in engine performances. In the preferred embodiment, the pitch of the helical fin 22 is approximately 24 inches, and is revolved once around its axis. The optimal revolution is not limited only to one revolution and can be more than one revolution depending on the efficiency. In reference to FIG. 16, the additional embodiment comprises two revolutions around its axis. The 2-D cross section of the revolved helical fin 22 entails that of a rectangle. The inlet edge 223 connects with the starting end 221 where the shape of the inlet edge 223 efficiently pushes air into the fluid inlet 23. The fluid moving device 2 may use only for air by-pass engines. There are two interconnected methods of generating thrust in the present invention; by passing air around the plurality of core components 3, and by igniting fuel with compressed air where compressed air is passed through the plurality of core components 3.

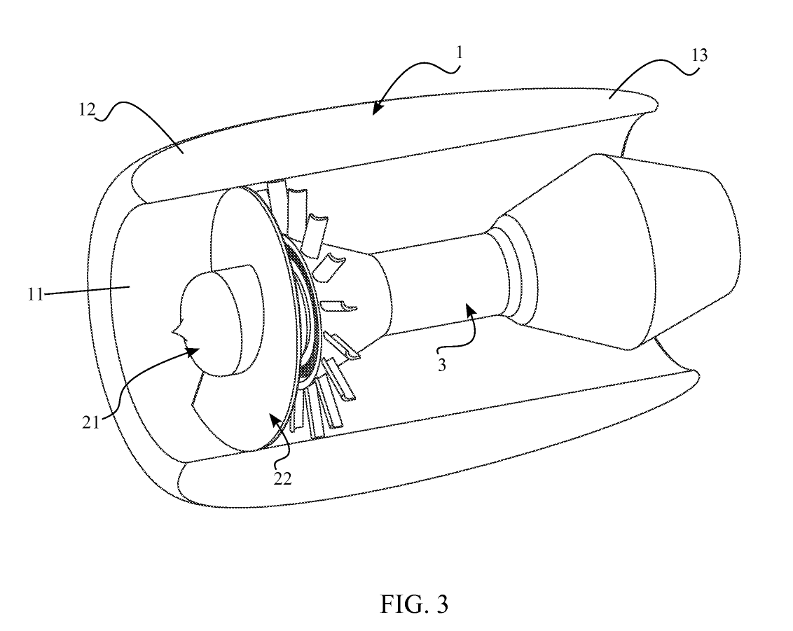

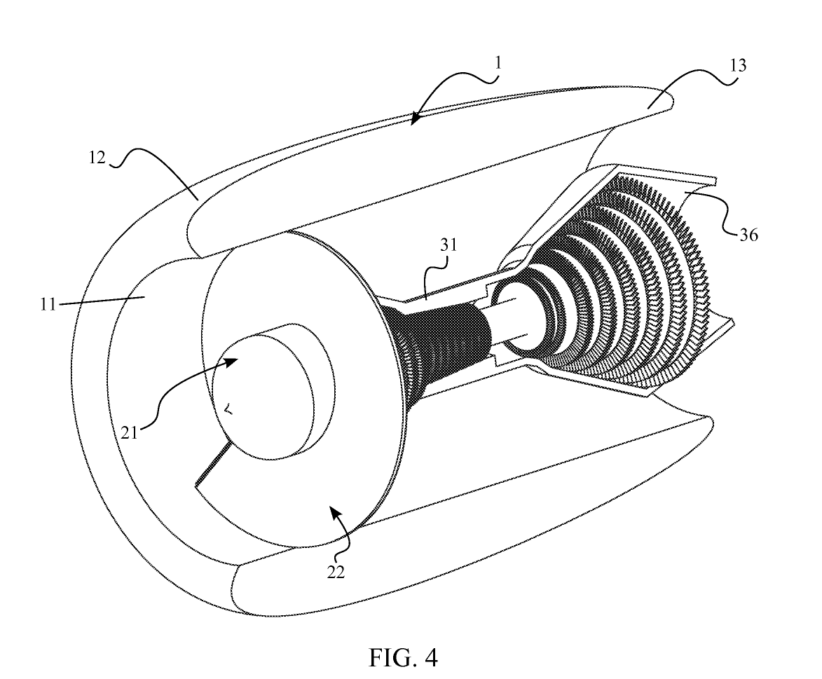

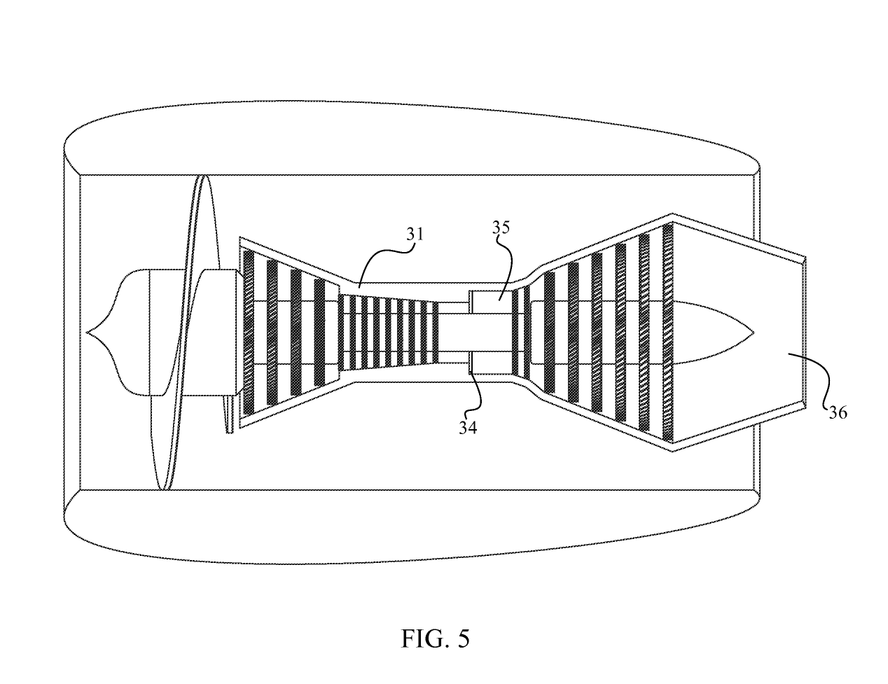

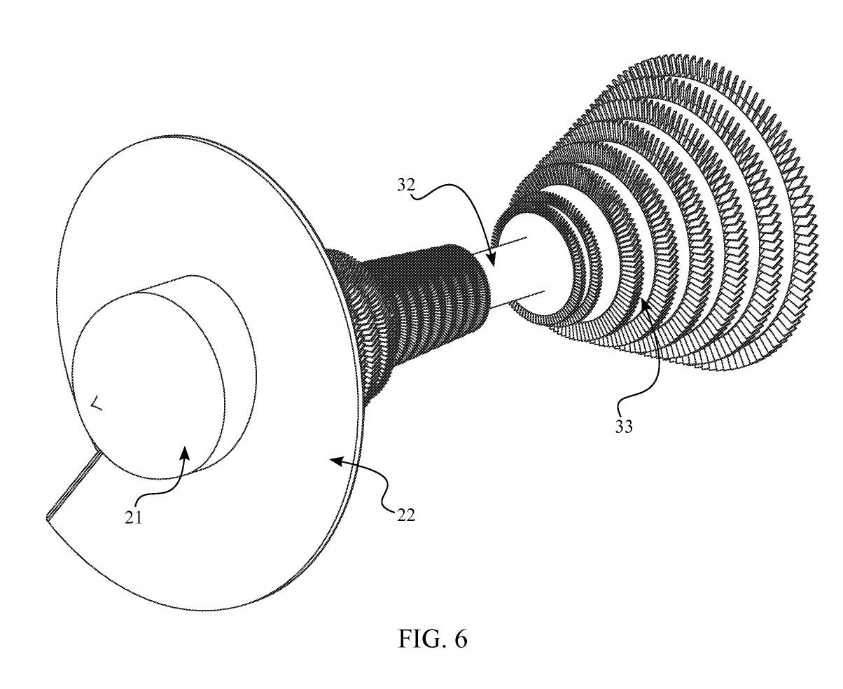

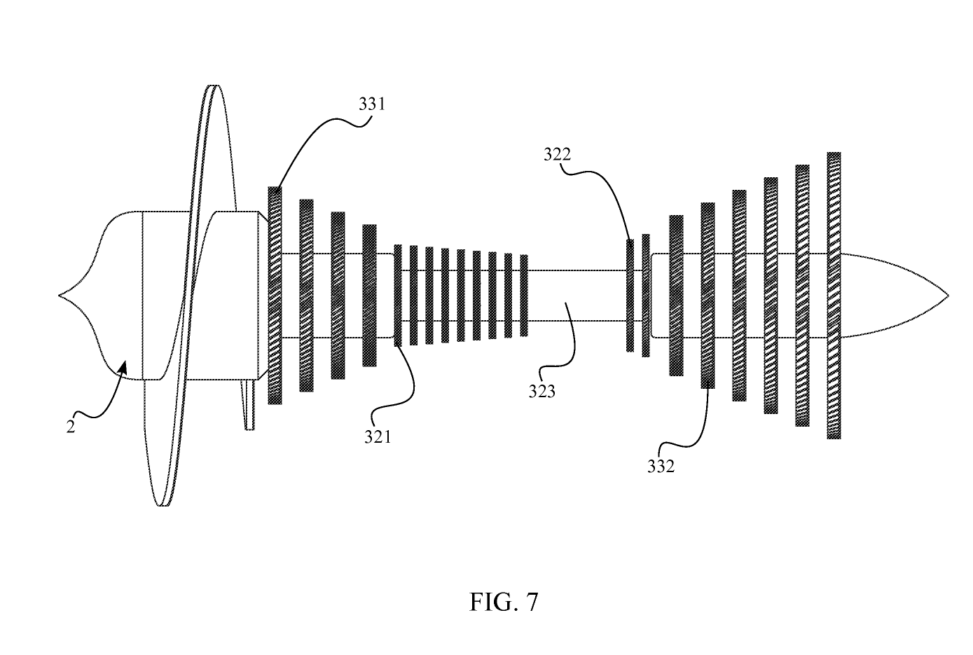

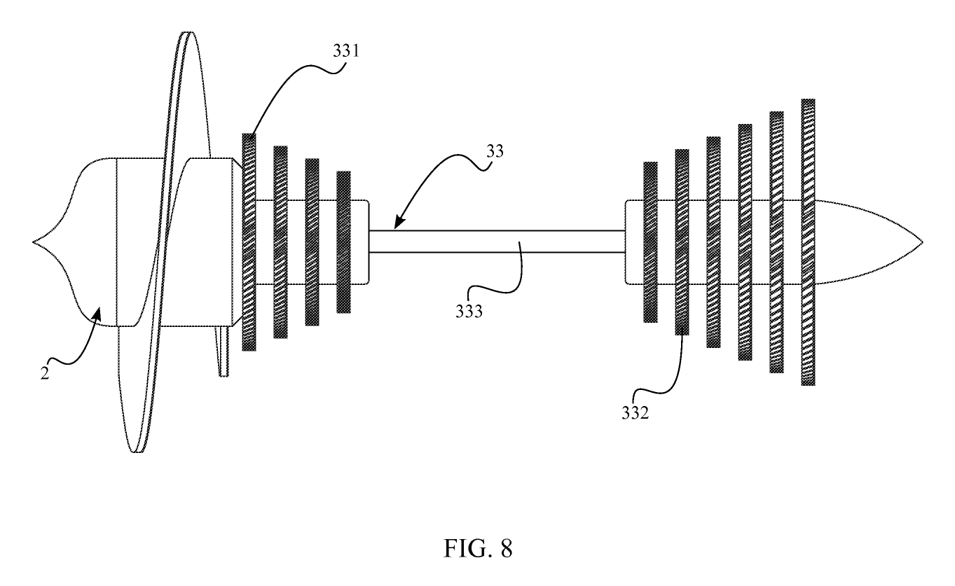

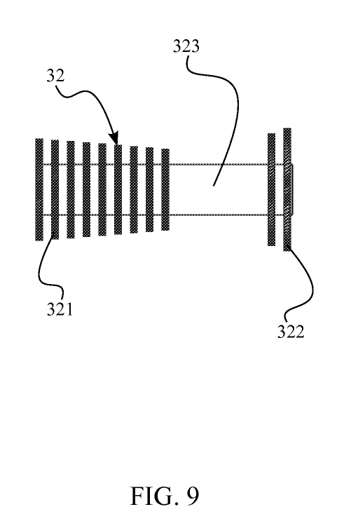

In reference to FIG. 5 and FIG. 7, the plurality of core components 3 comprises a compartment holder 31, a high spool 32, a low spool 33, a diffuser 34, a combustor 35, and an exit nozzle 36. In reference to FIG. 3, the compartment holder 31 is concentrically positioned within the intake opening 11 and connected with the outer casing 1. In reference to FIG. 4, the compartment holder 31 functions as the housing for the high spool 32, the low spool 33, the diffuser 34, and the combustor 35. The exit nozzle 36 is positioned on the compartment holder 31 and adjacently positioned with the back end 13. In reference to FIG. 6 and FIG. 9, the high spool 32 comprises a high pressure compressor 321, a high pressure turbine 322, and a high pressure shaft 323. The high pressure compressor 321 and the high pressure turbine 322 are oppositely positioned with the high pressure shaft 323 and concentrically connected to the high pressure shaft 323. The diffuser 34 and the combustor 35 are positioned in between the high pressure compressor 321 and the high pressure turbine 322 and concentrically inserted around the high pressure shaft 323. In reference to FIG. 6 and FIG. 8, the low spool 33 comprises a low pressure compressor 331, a low pressure turbine 332, and a low pressure shaft 333.

The low pressure shaft 333 is concentrically traversed through the low pressure compressor 331 and the low pressure turbine 332. The high spool 32 is positioned in between the low pressure compressor 331 and the low pressure turbine 332, and the high pressure spool positions around the low pressure shaft 333. The connector cavity 212 in the fluid moving device 2 connects with the low pressure shaft 333 where the fluid moving device 2 is positioned in front of the low pressure compressor 331. An optional shock absorber can also be configured on the low pressure shaft 333 or within the connector cavity 212 to absorb the impulsive load, similar to a shock absorber located on an automobile strut.

The fluid moving device 2 distributes air fluid into the intake opening 11 through the fluid inlet 23. The inlet edge 223 and the conical section 214 allow air fluid to efficiently enter into the intake opening 11. Entered air fluid is then divided into an interior core flow and an exterior core flow by the compartment holder 31 according to the bypass ratio. According to the bypass ratio, majority of entered air fluid is considered as the exterior core flow. The exterior core flow flows around the plurality of core compartment creating most of the thrust in the present invention. The interior core flow flows through the low pressure compressor 331 and the high pressure compressor 321. The low pressure compressor 331 and the high pressure compressor 321 significantly increase the temperature and the pressure of the interior core flow as they compressed the interior core flow within the compartment holder 31. Since the interior core flow flows with increase velocity, the interior core flow needs to slow down before entering into the combustor 35 while keeping the existing temperature and pressure. When the interior core flow penetrates through the diffuser 34, the diffuser 34 decreases the velocity of the interior core flow and keeps the existing temperature and the pressure. Then the interior core flow enters into the combustor 35 and ignites with the jet fuel. After the interior core flow is ignited, the pressurized the interior core flow respectively flows pass the high pressure turbine 322 and the low pressure turbine 332 and exits through the exit nozzle 36. The high pressure turbine 322 is positioned within the compartment holder 31 only to extract energy from the interior core flow so that the high pressure compressor 321 can be rotated. The low pressure turbine 332 is positioned within the compartment holder 31 to extract energy from the interior core flow so that the low pressure compressor 331 and the fluid moving device 2 can be rotated.

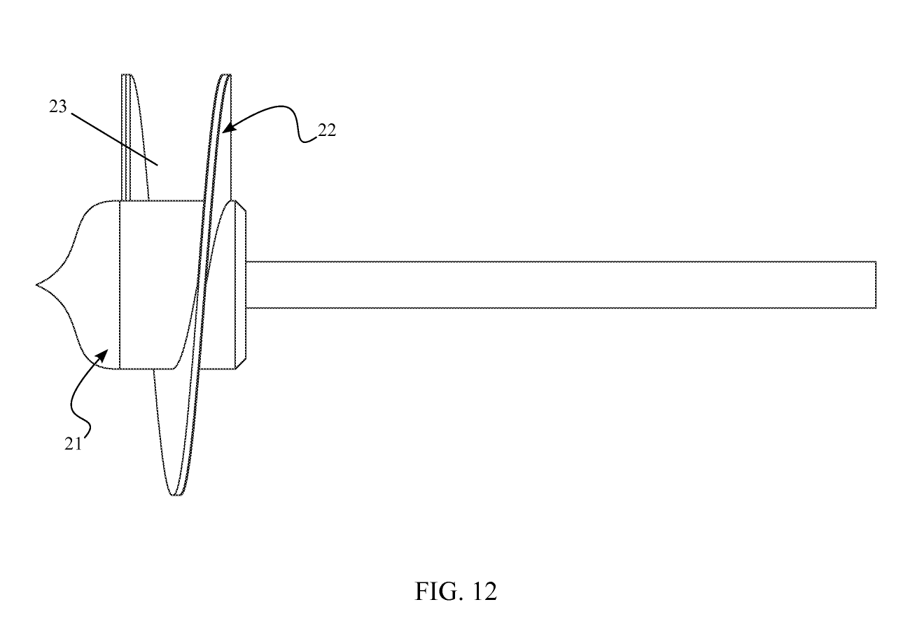

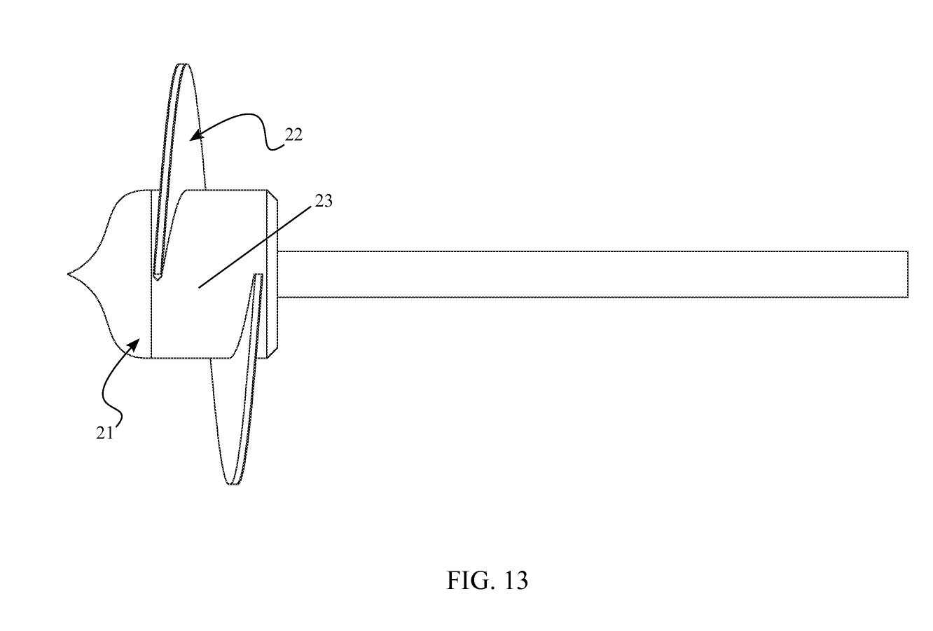

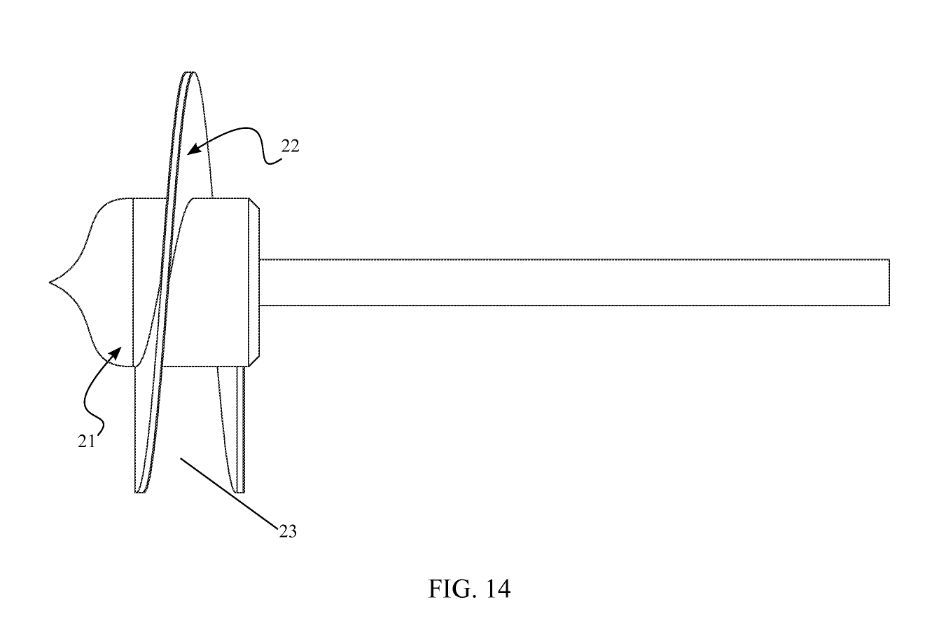

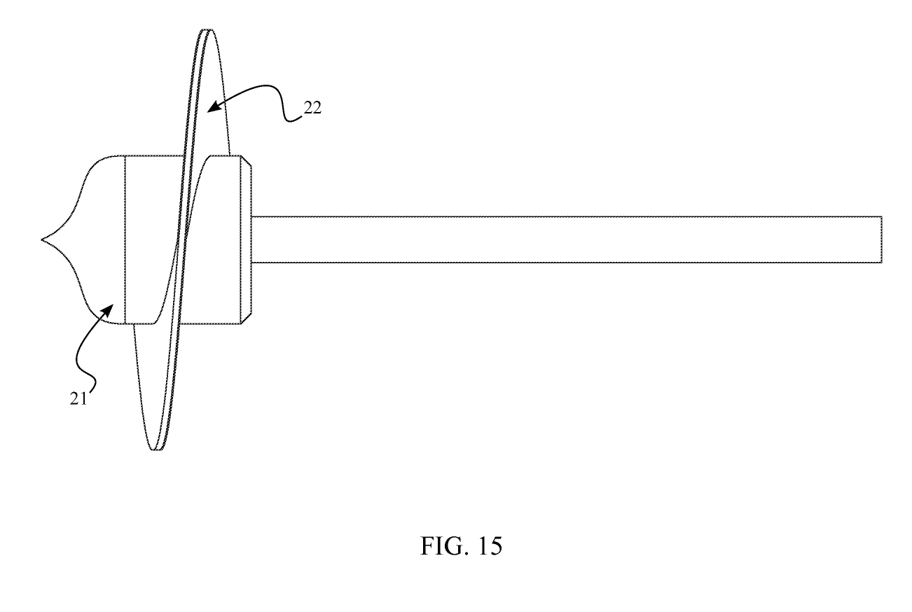

The fluid moving device 2 can be configured to rotate in the clockwise direction and the counter-clockwise direction. In reference to FIG. 12, FIG. 13, FIG. 14, and FIG. 15, the fluid moving device respectively illustrates 0 degree rotational angle, 90 degree rotational angle, 180 degree rotational angle, and 270 degree rotational angle. The fluid moving device 2 increases the impact resistance of aircraft engines. Because of the consistent homogeneities, where the consistent homogeneities are the uniform geometry around its rotational axis, in the helical fin 22, the advancement in the field of balance rotation can also be considered. The manufacturability of the fluid moving device 2 compare to traditional turbofan designs is that the geometry is flat sheeted revolving around an axis. This process involves non-complex elements widely accessible to most manufacturers. The accomplishments of the present invention are to solve the birdstrike and foreign body impact threats to aircraft engines by accommodating a more rigid and stiff inlet rotor. Also, the aspects of manufacturability, field maintenance and upkeep, and performance and efficiency are enhanced due to a simply designed, rigid and durable, and lightweight yet strong structure.

Although the invention has been explained in relation to its preferred embodiment, it is to be understood that many other possible modifications and variations can be made without departing from the spirit and scope of the invention as hereinafter claimed.

What is claimed is:

1. A system of fan-less thrust generating apparatus for air by-pass engine comprises,
an outer casing;
a fluid moving device;
a plurality of core components;
the outer casing comprises a front end, a back end, and an intake opening;
the fluid moving device comprises a hub, a helical fin, and a fluid inlet;
the plurality of core components comprises a compartment holder, a high spool, a low spool, a diffuser, a combustor, and an exit nozzle;
the fluid moving device being connected to the plurality of core components; and
the fluid moving device and the plurality of core components being positioned within the intake opening.

2. The system of fan-less thrust generating apparatus for air by-pass engine as claimed in claim 1 comprises,
the intake opening being concentrically positioned within the outer casing;
the front end and the back end being oppositely positioned in the outer casing; and
the intake opening being traversed through the front end and the back end.

3. The system of fan-less thrust generating apparatus for air by-pass engine as claimed in claim 1 comprises,
the helical fin being radially positioned from the hub; and
the fluid inlet being adjacently positioned with the hub and the helical fin.

4. The system of fan-less thrust generating apparatus for air by-pass engine as claimed in claim 1 comprises,
the compartment holder being concentrically positioned within the intake opening;
the compartment holder being connected with the outer casing;
the high spool, the low spool, the diffuser, and the combustor being positioned within the compartment holder; and
the exit nozzle being adjacently positioned with the back end and the compartment holder.

5. The system of fan-less thrust generating apparatus for air by-pass engine as claimed in claim 4 comprises,
the high spool comprises a high pressure compressor, a high pressure turbine, and a high pressure shaft;
the low spool comprises a low pressure compressor, a low pressure turbine, and a low pressure shaft;
the high pressure compressor and the high pressure turbine being oppositely positioned with the high pressure shaft and concentrically connected with the high pressure shaft;
the diffuser and the combustor being positioned in between the high pressure compressor and the high pressure turbine and concentrically connected with the high pressure shaft;
the low pressure shaft being concentrically traversed through the low pressure compressor and the low pressure turbine;
the high spool being positioned in between the low pressure compressor and the low pressure turbine; and
the high spool being positioned around the low pressure shaft.

6. The system of fan-less thrust generating apparatus for air by-pass engine as claimed in claim 4 comprises,
the fluid moving device being adjacently positioned with the front end; and
the hub being concentrically connected to the low pressure shaft.

7. An apparatus for a fluid moving device in air by-pass engine comprises,
a hub;
a helical fin;
a fluid inlet;
the hub comprises a flat surface, a cylindrical section, and a conical section;
the helical fin comprises a starting end, a final end, a first layer, a middle layer, a second layer, an inside rim, and an inlet edge;
the fluid inlet being adjacently position with the starting end; and
the helical fin being radially positioned around the hub.

8. The apparatus for a fluid moving device in air by-pass engine as claimed in claim 7 comprises,
the cylindrical section being positioned in between the flat surface and the conical section;
the flat surface being connected to the cylindrical section; and
the conical section being connected to the cylindrical section.

9. The apparatus for a fluid moving device in air by-pass engine as claimed in claim 8 comprises,
the flat surface comprises a connector cavity;
the connector cavity being concentrically traversed through the flat surface; and
the connector cavity being concentrically positioned within the cylindrical surface.

10. The apparatus for a fluid moving device in air by-pass engine as claimed in claim 7 comprises,
the inside rim concentrically positioned within the helical fin;
the first layer, the middle layer, and the second layer being radially positioned from the inside rim;
the middle layer being positioned in between the first layer and the second layer;
the first layer and the second layer being oppositely connected to the middle layer;
the starting end and the final end being helically connected by the first layer, the middle layer, and the second layer; and
the inlet edge being connected to the starting end.

11. The apparatus for a fluid moving device in air by-pass engine as claimed in claim 7 comprises,
the fluid inlet being positioned in between the starting end and the helical fin; and
the fluid inlet being adjacently positioned with the cylindrical section.

12. The apparatus for a fluid moving device in air by-pass engine as claimed in claim 7 comprises,
the inside rim being concentrically positioned around the cylindrical section;
the starting end being adjacently positioned below the conical section; and
the final end being adjacently positioned with the flat surface.
